(19) United States
(12) Patent Application Publication
(10) Pub. No.: US 2007/0016628 A1
(43) Pub. Date: Jan. 18, 2007

(54) Classification system for versionable objects

(75) Inventors: John William Barrs, Austin, TX (US); Michael Wayne Brown, Georgetown, TX (US); Paul Stuart Williamson, Round Rock, TX (US)

Correspondence Address: DUKE W. YEE;YEE & ASSOCIATES, P.C., P.O. BOX 802333, DALLAS, TX, 75380, US

(73) Assignee: Lenevo (Singapore) Pte.Ltd., Singapore (SG)

(21) Appl. No.: 11/181,403

(22) Filed: Jul. 14, 2005

(51) Int. Cl. G06F 17/30

(52) U.S. Cl. 707/203

(57) ABSTRACT

A computer implemented method, apparatus, and computer usable code for managing versioning data for objects in a virtual machine. A request to allocate an object is received, wherein the request identifies a plurality of parameters for classifying the object. An entry for the object is created in a versioning data structure using the plurality of parameters received in the request. The versioning data structure is used to store delta data for change in the data for the object and wherein the object is associated with the data structure. When a change in the data for the object occurs, the delta data is stored in the versioning data structure based on the plurality of parameters. A particular version of the object may be retrieved using the plurality of parameters.

### BACKGROUND OF THE INVENTION

1. Field of the Invention

The present invention relates to an improved data processing system and in particular to a method and apparatus for processing data. Still more particularly, the present invention relates to a method, apparatus, and computer instructions for an automated, incremental versioning, backup and restore mechanism for data elements within a computer system.

2. Description of the Related Art

Data storage components, variables, collections, and multi-dimensional collections are used throughout all computer applications. During the execution of an application, the contents of these types of data storage elements will change or evolve. These changes occur due to modifications or updates to the data. These changes may be made by user input or through programmatic means. As the program logic of an application progresses, situations often arise in which the program state and the content of the data storage elements need to be reset to a prior state. This state may be an arbitrary state selected by the user or programmatically by an application. Mechanisms for incrementally saving and resetting data to a prior known state are present in many applications.

Currently available mechanisms are found in applications, such as word processors, for resetting or rolling back to a previous state. A word processor may allow a user to undo changes to a document, such as deletions, insertions, or formatting changes.

A significant problem with existing mechanisms is that they are prone to inefficiencies and require explicit management by the application programmer or end user. Therefore, it would be advantageous to have an improved method, apparatus, and computer instructions for data versioning and recovery management.

### BRIEF SUMMARY OF THE INVENTION

The present invention provides a computer implemented method, apparatus, and computer usable code for managing versioning data for objects in a virtual machine. A request to allocate an object is received, wherein the request identifying a plurality of parameters for classifying the object. An entry for the object is created in a versioning data structure using the plurality of parameters received in the request. The versioning data structure is used to store delta data for change in the data for the object and wherein the object is associated with the data structure. When a change in the data for the object occurs, the delta data is stored in the versioning data structure based on the plurality of parameters. A particular version of the object may be retrieved using the plurality of parameters.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the aspects of the present invention may be implemented;

FIG. 2 is a block diagram of a data processing system shown in which aspects of the present invention may be implemented;

FIG. 3 is a block diagram of a Java virtual machine in accordance with an illustrative embodiment of the present invention;

FIG. 4 is a diagram illustrating components used in data versioning and recovery in accordance with an illustrative embodiment of the present invention;

FIG. 5 is a diagram illustrating components used in providing data versioning and recovery management in accordance with an illustrative embodiment of the present invention;

FIG. 6 is a diagram illustrating objects and a delta linked list in accordance with an illustrative embodiment of the present invention;

FIG. 7 is a diagram illustrating a classification system for versionable objects in accordance with an illustrative embodiment of the present invention;

FIG. 8 is a flowchart of a process for creating a class in accordance with an illustrative embodiment of the present invention;

FIG. 9 is a flowchart of a process for creating a class object in accordance with an illustrative embodiment of the present invention;

FIG. 10 is a flowchart of a process for storing delta data in accordance with an illustrative embodiment of the present invention; and

FIG. 11 is a flowchart of a process for returning a prior version of a class object to a requester in accordance with an illustrative embodiment of the present invention.

### DETAILED DESCRIPTION OF THE PREFERRED EMBODIMENT

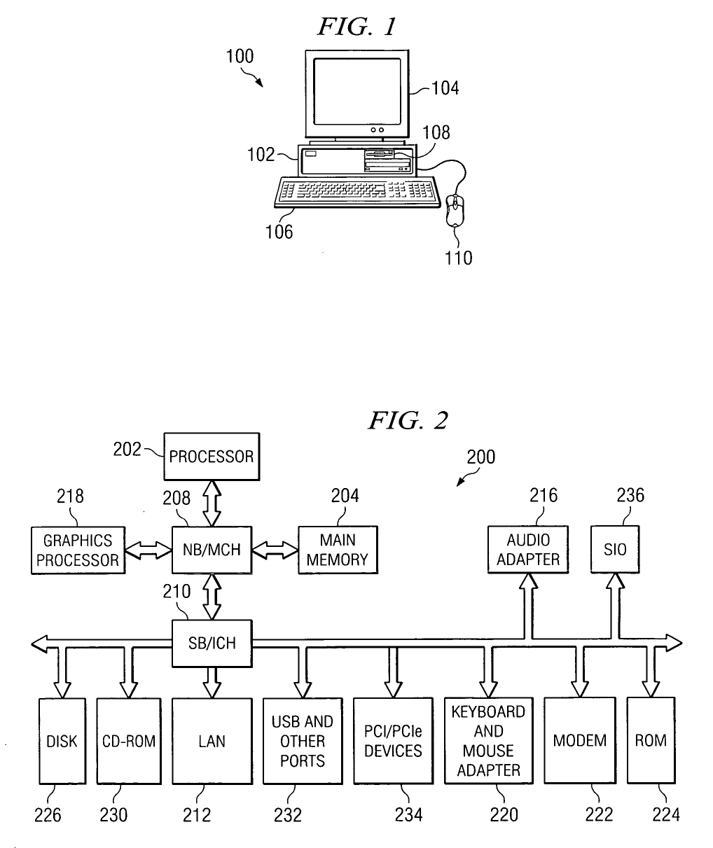

With reference now to the figures and in particular with reference to FIG. 1, a pictorial representation of a data processing system in which the aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer, such as computer 100 in FIG. 1, in which code or instructions implementing the processes of the present invention may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to ICH 210. PCI/PCIe devices may include, for example, Ethernet adapters, add-in cards, PC cards for notebook computers, etc. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to ICH 210.

An operating system runs on processor 202 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 204 for execution by processor 202. The processes of the present invention are performed by processor 202 using computer implemented instructions, which may be located in a memory such as, for example, main memory 204, read only memory 224, or in one or more peripheral devices.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

As some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 204 or a cache such as found in MCH 208. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

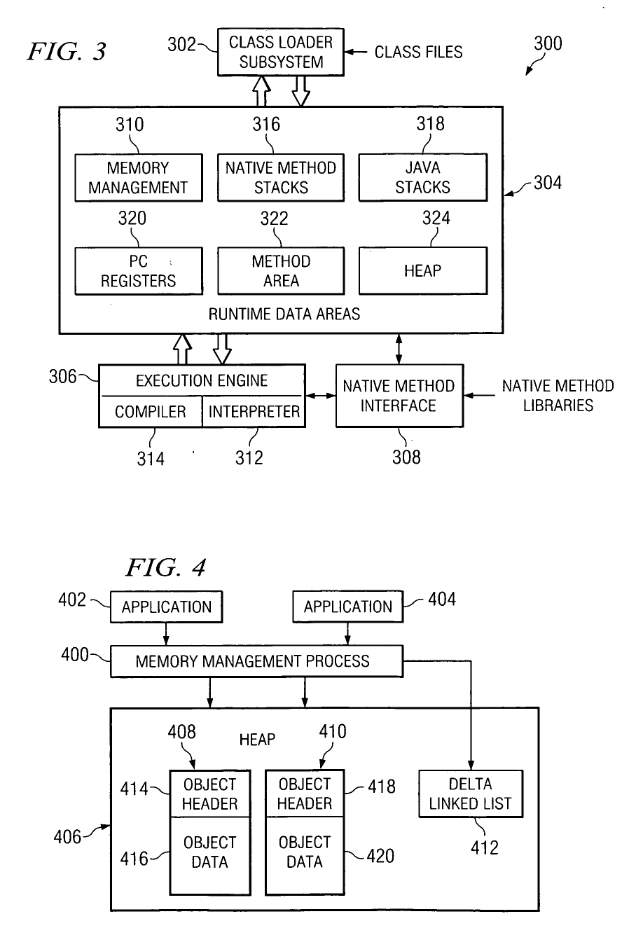

With reference now to FIG. 3, a block diagram of a Java virtual machine is depicted in accordance with an illustrative embodiment of the present invention. Java virtual machine 300 includes class loader subsystem 302, which is a mechanism for loading types, such as classes and interfaces, given fully qualified names. Java virtual machine 300 also contains runtime data areas 304, execution engine 306, native method interface 308, and memory management 310. Execution engine 306 is a mechanism for executing instructions contained in the methods of classes loaded by class loader subsystem 302. Execution engine 306 may be, for example, Java interpreter 312 or just-in-time compiler 314. Native method interface 308 allows access to resources in the underlying operating system. Native method interface 308 may be, for example, the Java Native Interface (JNI).

Runtime data areas 304 contain native method stacks 316, Java stacks 318, PC registers 320, method area 322, and heap 324. These different data areas represent the organization of memory needed by Java virtual machine 300 to execute a program.

Java stacks 318 are used to store the state of Java method invocations. When a new thread is launched, the Java virtual machine creates a new Java stack for the thread. The Java virtual machine performs only two operations directly on Java stacks: it pushes and pops frames. A thread's Java stack stores the state of Java method invocations for the thread. The state of a Java method invocation includes its local variables, the parameters with which it was invoked, its return value, if any, and intermediate calculations. Java stacks are composed of stack frames. A stack frame contains the state of a single Java method invocation. When a thread invokes a method, the Java virtual machine pushes a new frame onto the Java stack of the thread. When the method completes, the Java virtual machine pops the frame for that method and discards it. The Java virtual machine does not have any registers for holding intermediate values; any Java instruction that requires or produces an intermediate value uses the stack for holding the intermediate values. In this manner, the Java instruction set is well defined for a variety of platform architectures.

Program counter (PC) registers 320 are used to indicate the next instruction to be executed. Each instantiated thread gets its own PC register and Java stack. If the thread is executing a Java virtual machine method, the value of the PC register indicates the next instruction to execute. If the thread is executing a native method, then the contents of the PC register are undefined.

Native method stacks 316 stores the state of invocations of native methods. The state of native method invocations is stored in an implementation-dependent way in native method stacks, registers, or other implementation-dependent memory areas. In some Java virtual machine implementations, native method stacks 316 and Java stacks 318 are combined.

Method area 322 contains class data while heap 324 contains all instantiated objects. The constant pool is located in method area 322 in these examples. The Java virtual machine specification strictly defines data types and operations. Most Java virtual machines choose to have one method area and one heap, each of which is shared by all threads running inside the Java virtual machine, such as Java virtual machine 300. When Java virtual machine 300 loads a class file, it parses information about a type from the binary data contained in the class file. Java virtual machine 300 places this type of information into the method area. Each time a class instance or array is created, the memory for the new object is allocated from heap 324. Java virtual machine 300 includes an instruction that allocates memory space within the memory for heap 324 but includes no instruction for freeing that space within the memory. Memory management 310 in the depicted example manages memory space within the memory allocated to heap 324. Memory management 310 may include a garbage collector, which automatically reclaims memory used by objects that are no longer referenced. Additionally, a garbage collector also may move objects to reduce heap fragmentation.

The present invention provides a memory management subsystem to provide for data versioning and recovery management. The mechanism of the present invention saves modifications or deltas in data when objects in memory are changed. A delta in data is the difference between the data in its prior version and its current version. The different deltas may be used to restore memory segments to a prior state. In these illustrative examples, the memory management subsystem may be, for example, memory management 310 and heap 324 in FIG. 3. The mechanism of the present invention modifies this heap to include data structure for restoring delta data for memory segments. In these examples, delta data represents changed values or data for a particular memory segment. This delta data is associated with an index. This index may take various forms, such as a number or a timestamp.

In particular, these changes between the prior data and the current data in its changed form are stored in a data structure, such as, for example, a linked list in a heap. The data structure is associated with a memory segment. In the illustrative examples, a memory segment is associated with the versioning data structure using at least one of a pointer and an offset. The mechanism of the present invention, in these illustrative examples, modifies the memory management system to automatically generate this linked list in the heap of a Java virtual machine without requiring any special requests from applications or the user.

Another feature of the present invention is an ability to classify a group of objects within a versionable set of objects that are tracked using a linked list. In other words, objects may be identified or classified using more than one parameter. For example, rather than merely using an object name to identify single objects for storing versions or restoring versions, multiple objects within a class that meet different parameters may be handled using this process.

For example, a type of version classification may be designated using this feature. A series of versions may be identified using, for example, parameters such as time, an index number, an object type, and pages. With this ability to classify versionable objects, queries may be made against these different classes in which a version is returned by multiple constructs or parameters. A versionable object is an object in which delta data is tracked for the object to allow restoration of the object to a prior version. The queries that may be used include, for example, all changes to page 4 made last Thursday.

Additionally, this classification feature may be applied to different groups of objects. For example, a versionable group “department” includes a versionable group of objects “employees”. The versionable group “employees” is a class within the versionable group “department”. As a result, a collection of classes may be versionable. In this manner, entire classes of objects may be queried or restored to prior versions.

Turning now to FIG. 4, a diagram illustrating components used in data versioning and recovery is depicted in accordance with an illustrative embodiment of the present invention. Memory management process 400 receives requests from applications, such as application 402 and application 404 to allocate objects. These objects are allocated from the available objects in heap 406. This heap may be, for example, heap 324 in FIG. 3. Memory management process 400 may be implemented in a memory management component, such as memory management 310 in FIG. 3.

In response to receiving these requests, data objects, such as data object 408 and data object 410, are allocated by memory management process 400. Additionally, delta linked list 412 is located within heap 406. This particular data structure contains a linked list of entries that identify delta data for various objects, such as object 408 and object 410.

In this example, object 408 includes object header 414 and object data 416. Object 410 includes object header 418 and object data 420. Object data 416 and object data 420 contain the data for objects 408 and 410 in their current state. Object header 414 includes a pointer or offset to delta linked list 412. In a similar fashion, object header 418 also includes an offset or header in the delta linked list 412.

If a request is received by memory management process 400 to restore one of the objects in heap 406 to a prior state, this process identifies the object and an index to identify the state that is desired. This index may be, for example, a numerical value or a timestamp. If, for example, object 408 is identified in the request, object header 414 is used to find delta linked list 412. This link list is managed by memory management process 400, which also calculates the delta data in these illustrative examples. The index in the request is used to identify the desired state for object 408. Based on the particular entry identified in linked list 412, linked list 412 may be traversed to make the appropriate changes to object 408 to return that object to its original state.

In these depicted examples, all of the delta data for all objects are stored within delta linked list 412. The entries that apply to a particular object may be identified through an object identifier that is found within each entry of delta linked list 412.

In other illustrative examples, a separate linked list data structure may be used for each object. In this case, the object header provides an offset to the particular linked list data structure for that object.

When application 402 changes an object, such as object 408, memory management process 400 creates an entry within delta linked list 412 to store the delta data for that object. Memory management process 400 can detect changes in a object using a number of different mechanisms. For example, the application, making a call to assign a value to an object being managed by the memory management process 400, the memory management process 400 detects this call and generates delta data. For example, the delta data may be the difference between the old value and the new value. In another example, all of the objects are examined periodically to see whether a change has occurred since the last time data for the objects was stored in delta linked list 412. This comparison is made, in this example, by comparing the data in the object with a previous copy of the data for the objects. In yet another example, an explicit API call may be made to generate a change in the object. The receipt of this call is used to detect the change in data.

Specifically, any changed values in object 408 and object 410 are stored within delta linked list 412 in association with the identification of these objects and an index for each object. In these examples, the index may be, for example, a numerical value or a timestamp. In this manner, all changes to objects 408 and 410 are stored within delta linked list 412. Thus, these objects may be returned to any prior state desired using this data structure. Delta linked list 412 may include additional parameters other than an identification of the object and the index for the object. For example, a class or grouping may be placed within delta linked list 412. This association of grouping may be used later to allow a particular version of a particular type of object to be returned in response to a query from an application. In these examples, the query is handled by memory management processor 400 through an API call made by the application. For example, the identification of a group in which the object belongs may be stored in delta linked list 412. This grouping may be, for example, a classification, such as department. This department may include individual objects or additional classes may be within this particular grouping. For example, the groups “employees” and “management” may be subclasses or versionable groups within the versionable group department. Depending on the implementation, the different parameters for the groupings or classifications may be stored in either the linked list or in an external data structure. In a preferred embodiment, they are stored in the delta linked list.

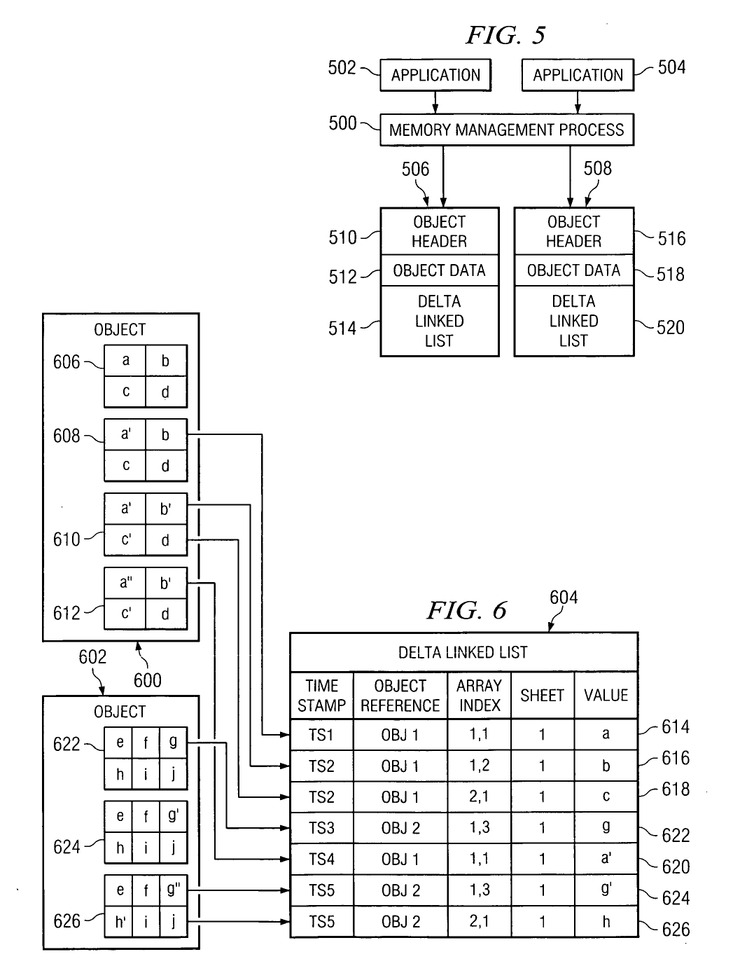

Turning next to FIG. 5, a diagram illustrating components used in providing data versioning and recovery management is depicted in accordance with an illustrative embodiment of the present invention. In this illustrative example, memory management process 500 receives requests from application 502 and application 504 to create objects for use by the applications. In this example, object 506 is created for use by application 502 and object 508 is created for use by application 504.

Memory management process 500 may be implemented within memory management 310 in FIG. 3. Objects 506 and 508 may be located in a heap, such as heap 324 in FIG. 3. Object 506 includes object header 510, object data 512, and delta linked list 514. Object header 510 includes an offset to point to the beginning of delta linked list 514 in this illustrative example. Object data 512 contains the current data for object 506. Delta linked list 514 contains entries that identify all of the delta data for object 506.

In a similar fashion, object header 516 provides an offset to the beginning of delta linked list 520. Object data 518 contains the current data for object 508. Delta linked list 520 contains all the delta data for changes made to object data 518. Additionally, information used to place objects into classifications also may be located within delta linked list 514 and 520. In this illustrative example, memory management process 500 automatically increases the size of object 506 in response to a request to allocate object 506. This increased size includes space needed to store delta data. This type of allocation for objects 506 and 508 is performed automatically without requiring an application or a user to request the additional memory to store delta data. Additionally, memory management process 500 may allocate more space for object 506 and object 508 as the object data and the delta data increase for these objects.

Turning now to FIG. 6, a diagram illustrating objects and a delta linked list is depicted in accordance with an illustrative embodiment of the present invention. In this example, object 600 and object 602 are examples of data elements requested by an application, such as applications 402 and 404 in FIG. 4. Space for object 600 and object 602 is allocated in a heap by a memory management subsystem. References to these data elements are returned to the applications for use. Additionally, the memory management subsystem also initializes delta linked list 604.

In these illustrative examples, object 600 and object 602 are examples of spreadsheets. Object 600 is referred to as Obj 1 and Object 602 is referred to as Obj 2 in FIG. 6 in this example.

Array 606 represents the initial state of object 600. Array 608 indicates that a change has been made to the value in cell (1,1). Array 610 indicates that changes have been made to object 600 in cells (1,2) and (2,1). Array 612 indicates that changes have been made to object 600 in cell (1,1). The initial change made in array 608 is stored as entry 614. Each of these entries includes a timestamp, which is used as the index. The entries also include an object reference to identify the object with which the entry is associated. These entries also include other parameters that may be used to designate types of classifications. For example, each of the entries in delta linked list 604 also contain a sheet used to identify the particular sheet in a spreadsheet object. A particular spreadsheet object may contain one or more sheets. This particular entry allows for classifying objects based on sheets contained in the objects. Of course, other types of parameters may be used in addition to or in place of this parameter in this example. The types and numbers of parameters used for classifying objects vary depending on the particular implementation and type of object.

The array index identifies the cell in which the change has been made. The value in the entry identifies the change value. In other words, when the value a is changed to value a′, the value a is stored in entry 614 to identify the delta between array 606 and array 608. The changes to array 610 are stored in entry 616 and 618. These two entries have the same timestamp because the changes were made at the same time by the application. Entry 620 identifies the change made to array 612 for object 600.

In a similar fashion, the data in object 602 is an example of a spreadsheet file and shows the different states of this object. Array 622 shows the initial state of object 602. Array 624 shows that a change has been made in cell (1,3). Array 626 shows that a change has been made in cells (1,3) and (2,1) for object 602. The change made to array 624 is recorded in delta linked list 604 as entry 622. The changes made to array 626 are shown in entries 624 and 626 in delta linked list 604. In these examples, the changes are made to sheet 1 within the different spreadsheet files.

As can be seen, these examples illustrate that the index or state for the deltas is associated with timestamps. An entry is made each time a change is made to one of the objects in these examples.

The current state of object 600 is shown in array 612. The current state of object 602 is shown in array 626. As a result, if a user, an application, or some other process wishes to return object 600 to a prior state, delta linked list 604 may be used to perform this restoration.

In this illustrative example, the prior state is identified through a timestamp. If the memory management subsystem receives a request identifying a particular timestamp and object, the object may be returned to that state. In this example, if the timestamp is Ts2 for object 600, the memory management subsystem may identify the most recent delta for object 600 and return it to the prior state. For example, a″ in cell (1,1) may be returned to a′ using entry 620. The mechanism of the present invention traverses the linked list from the most current entry to the entry identified by the timestamp. Entries for objects other than the selected object are ignored.

Next, the process identifies entries 616 and 618 as those corresponding to timestamp Ts2. The values for b′ in cell (2,1) are returned to b and for c′ in cell (2,1) are returned to c.

This type of traversal and restoration of data is provided as one manner in which the object may be restored to a prior state. Of course, any process used to return an object to a prior state using delta data may be employed in these illustrative examples.

The delta in data may be identified or calculated in a number of different ways. In these examples, the delta may be calculated using an exclusive OR (XOR). In other words, the value of prior data may be XOR′d with the value of the current data to identify the change in the current data as compared to the prior data. The result of this function is considered the delta in the data in this example. With this delta the current data may be restored to the value of the current data. The data may be, for example, the values for data in all of the heaps managed by a memory management system. The delta in the data also may be calculated using Moving Picture Experts Group (MPEG) processes, such as MPEG 2. With these processes every delta is similar to a video frame with respect to normal use in processing video data. Instead, the deltas are for one or more objects. As with a video, in which not every pixel necessarily changes from frame to frame, not all of the data elements within a object may change from one delta to another delta. Compression algorithms, similar to MPEG2, can be employed which minimize the amount of memory required to store the necessary information, or delta, to restore the objects to prior values.

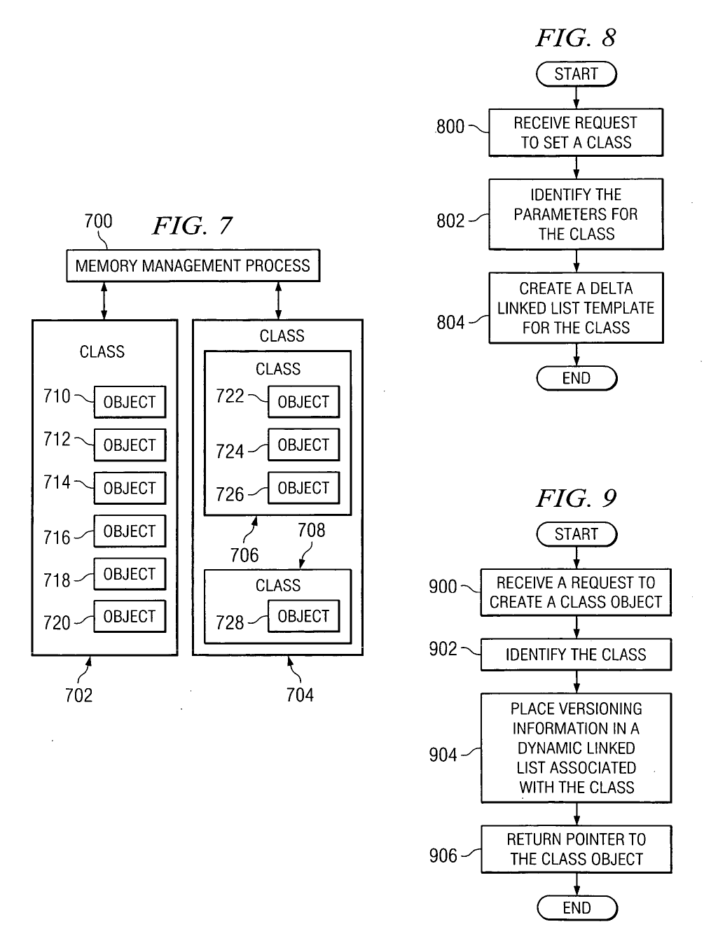

With reference next to FIG. 7, a diagram illustrating a classification system for versionable objects is depicted in accordance with an illustrative embodiment of the present invention. In these examples, memory management process 700 manages and handles the different classes. Memory management process 700 may be implemented as memory management 310 in FIG. 3.

In this example, class 702 and class 704 are present. Class 704 contains subclasses. These subclasses are class 706 and class 708.

Class 702 contains objects 710, 712, 714, 716, 718, and 720. Class 706 contains objects 722, 724, and 726. Class 708 contains a single object, object 728. Class 702 may be predesignated or set by an application, such as application 402 in FIG. 4. When an application sets or defines a class, this definition is made through an API. For example, set (*time, *index, *objects, *pages) may be used to set a classification for objects within class 702. Each of these objects within the class contain information for the different parameters set by the API call. As a result, a query may be made based on the parameters set for class 702. For example, all changes to page 4 last Thursday may be used as a query to return one or more objects from class 702.

Additionally, with subclasses, objects may be returned based on queries for the different classes. As an example, class 704 may be “department”. Class 706 is “employees”, while class 708 is “manager”. As a result, if a query is made for all employees in a department, the objects in class 706 may be returned. Additionally, other parameters may be set within class 706, such as start date and birth date. As a result, a query may be made for employees having a start date of 2002. This type of query will return any object within class 706 meeting that parameter. A query for managers will return object 728 in class 708. The classifications for these different examples are stored in the delta linked list. This information may be stored in a separate data structure or directly in association with the objects. For example, classifications are defined via metadata constructs. The classification value may be stored with the version objects. The different objects within these classes are versionable. As a result, changes, which are referred to as delta data, are restored in a delta linked list to allow objects to be returned to a prior version. In this manner, objects meeting a particular parameter or even entire classes of objects may be returned to a prior state.

With reference to FIG. 8, a flowchart of a process for creating a class is depicted in accordance with an illustrative embodiment of the present invention. The process illustrated in FIG. 8 may be implemented in a memory management process, such as memory management process 700 in FIG. 7. This process is used to create classes of versionable objects.

The process begins by receiving a request to set a class (step 800). In these examples, the request is made by an application sending an API call to the process. This API call includes the different parameters that should be used for the class. Next, the process identifies the parameters for the class (step 802). These parameters may be, for example, a particular page in a document, a date, an organizational parameter, or a type of document. The organizational parameter may be, for example, a department in a business, such as accounting or human resources.

Additionally, the organizational parameter may be, for example, a school or a particular grade. Document parameters may include, for example, spreadsheets or word processors. The document types may be even more specific, such as, for example, personnel memorandums, checks, or even magazines. Then, the process creates a delta linked list template for the class (step 804) with the process terminating thereafter.

Turning to FIG. 9, a flowchart of a process for creating a class object is depicted in accordance with an illustrative embodiment of the present invention. The process illustrated in FIG. 9 may be implemented in a memory management process, such as memory management process 700 in FIG. 7. This process creates a class object in response to receiving a call from an application in these examples. In this example, the process receives the request in the form of an API call from an application requesting an object.

The process begins by receiving a request to create a class object (step 900). This request is received as an API call from an application in these illustrative examples. Next, the process identifies the class (step 902) and the process places versioning information in a dynamic linked list associated with the class (step 904). In this example, the class is identified in step 902 by examining parameters within the request. The process returns a pointer to the class object to the requester (step 906) with the process terminating thereafter.

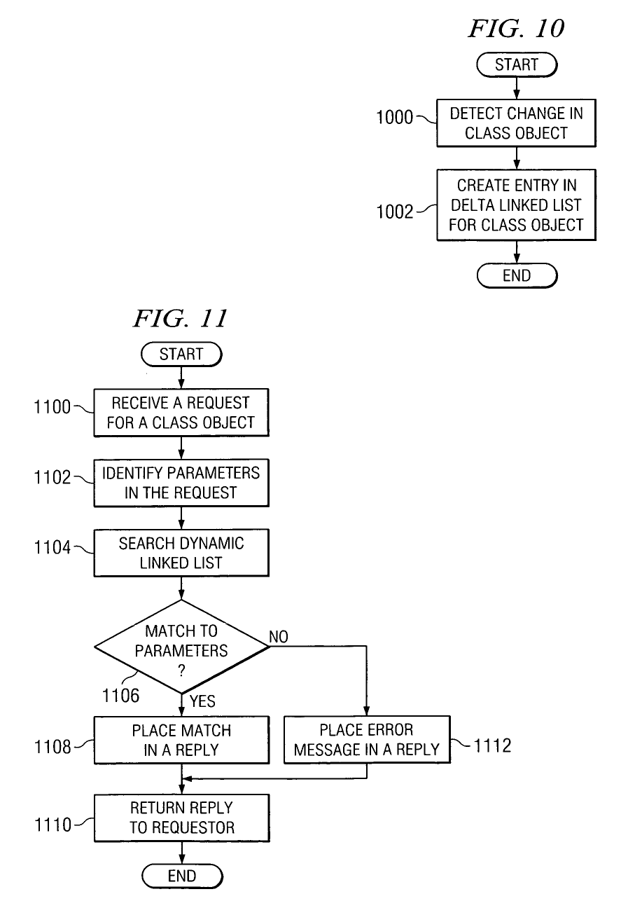

In the examples, changes to the linked list occur as new versions of objects are created or deleted. Turning now to FIG. 10, a flowchart of a process for storing delta data is depicted in accordance with an illustrative embodiment of the present invention. The process illustrated in FIG. 10 may be implemented in a memory management process, such as memory management process 700 in FIG. 7.

The process begins by detecting change in a class object (step 1000). This step may occur in different ways. For example, when the memory management process receives a request to change data in a class object, this request is used to detect the change. In another example, when the application makes a call to assign a value to an object being managed by the memory management process, the memory management process detects this call and generates delta data. Next, the process creates an entry in the delta linked list for class object (step 1002) with the process terminating thereafter. This linked list may be a combined linked list for all class objects. Alternatively, the linked list may be one created for the particular object when the object was allocated or as a separate linked list associated with this particular object.

With reference to FIG. 11, a flowchart of a process for returning a prior version of a class object to a requester is depicted in accordance with an illustrative embodiment of the present invention. The process illustrated in FIG. 11 may be implemented in a memory management process, such as memory management process 700 in FIG. 7.

The process begins by receiving a request for a class object (step 1100). In these examples, the request is received from a requester, such as an application making an API call to the memory management process. Next, the process identifies parameters in the request (step 1102). The process searches a dynamic linked list (step 1104). In this example, the dynamic linked list is managed by the memory management subsystem and contains the version classification identifier. Next, a determination is made as to whether a match to parameters is present (step 1106). If a match to parameters is present, the process places the match in a reply (step 1108) and returns the reply to the requester (step 1110). Turning back to step 1106, if a match to parameters is absent, the process places error message in a reply (step 1112) and returns to step 1110, with the process terminating thereafter.

Thus, in this manner, the present invention provides a method, apparatus, and computer instructions for versioning objects. In particular, the mechanism of the present invention may be used to handle classes or groupings of objects. The saving of delta data are stored in a manner that allows queries to be made on different parameters or classes. The mechanism of the present invention allows for entire classes of objects to be restored to a prior version or for particular objects within a class meeting particular parameters to be restored to a prior version.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for managing versioning data for objects in a virtual machine, the computer implemented method comprising:
receiving a request to allocate an object, wherein the request identifying a plurality of parameters for classifying the object;
creating an entry for the object in a versioning data structure using the plurality of parameters received in the request, wherein the versioning data structure is used to store delta data for change in the data for the object and wherein the object is associated with the data structure;
detecting a change in the data for the object; and
storing the delta data in the versioning data structure based on the plurality of parameters in response to the change in the data for the object, wherein a particular version of the object may be retrieved using the plurality of parameters.

2. The computer implemented method of claim 1 further comprising:
receiving a subsequent request to retrieve a particular version of the object, wherein the request includes values for the plurality of parameters; and
returning the particular version of the object using values for the plurality of parameters.

3. The computer implemented method of claim 2, wherein the returning step comprises:
returning the object to a prior state using the particular version of the object.

4. The computer implemented method of claim 1, wherein the plurality of parameters includes at least one of a classification for the object, a page, a file type, a grouping for the object with other objects, a time stamp, a department, and a page.

5. The computer implemented method of claim 1, wherein the plurality of parameters includes a parameter identifying a group and subgroup for the object.

6. The computer implemented method of claim 1, wherein the request is received using an application programming interface call.

7. The computer implemented method of claim 1, wherein the object is associated with the versioning data structure using at least one of a pointer and an offset.

8. The computer implemented method of claim 1, wherein the request is received from a requester and further comprising:
returning a reference to the object to the requestor.

9. The computer implemented method of claim 1, wherein the computer implemented method is located in a memory management process.

10. A computer program product comprising:
a computer usable medium having computer usable program code for managing versioning data for objects in a virtual machine, said computer program product including:
computer usable program code for receiving a request to allocate an object, wherein the request identifying a plurality of parameters for classifying the object;
computer usable program code for creating an entry for the object in a versioning data structure using the plurality of parameters received in the request, wherein the versioning data structure is used to store delta data for change in the data for the object and wherein the object is associated with the data structure;
computer usable program code for detecting a change in the data for the object; and
computer usable program code for storing the delta data in the versioning data structure based on the plurality of parameters in response to the change in the data for the object, wherein a particular version of the object may be retrieved using the plurality of parameters.

11. The computer program product of claim 10 further comprising:
computer usable program code for receiving a subsequent request to retrieve a particular version of the object, wherein the request includes values for the plurality of parameters; and
computer usable program code for returning the particular version of the object using values for the plurality of parameters.

12. The computer program product of claim 11, wherein the computer usable program code for returning the particular version of the object using values for the plurality of parameters comprises:
computer usable program code for returning the object to a prior state using the particular version of the object.

13. The computer program product of claim 10, wherein the plurality of parameters includes at least one of a classification for the object, a page, a file type, a grouping for the object with other objects, a time stamp, a department, and a page.

14. The computer program product of claim 10, wherein the plurality of parameters includes a parameter identifying a group and subgroup for the object.

15. The computer program product of claim 10, wherein the request is received using an application programming interface call.

16. The computer program product of claim 10, wherein the object is associated with the versioning data structure using at least one of a pointer and an offset.

17. The computer program product of claim 10, wherein the request is received from a requestor and further comprising:
computer usable code for returning a reference to the object to the requester.

18. A data processing system comprising:
a bus;
a communications unit connected to the bus;
a memory connected to the bus, wherein the memory includes a set of instructions; and
a processor unit connected to the bus, wherein the processor unit executes the computer usable code to receive a request to allocate an object, wherein the request identifying a plurality of parameters for classifying the object; create an entry for the object in a versioning data structure using the plurality of parameters received in the request, wherein the versioning data structure is used to store delta data for change in the data for the object and wherein the object is associated with the data structure; detect a change in the data for the object; and store the delta data in the versioning data structure based on the plurality of parameters in response to the change in the data for the object, wherein a particular version of the object may be retrieved using the plurality of parameters.

19. The data processing system of claim 18, wherein the processor unit further executes the computer usable code to receive a subsequent request to retrieve a particular version of the object, wherein the request includes values for the plurality of parameters; and return the particular version of the object using values for the plurality of parameters.

20. The data processing system of claim 19, wherein in executing the computer usable code to return the particular version of the object using values for the plurality of parameters, the processor further executes the computer usable code to return the object to a prior state using the particular version of the object.
